(19) United States
(12) Patent Application Publication
(10) Pub. No.: US 2004/0123506 A1
(43) Pub. Date: Jul. 1, 2004

(54) Necktie protector and method for messaging, advertising and marketing using the same

(76) Inventors: James K. Liechty, Fremont, CA (US); Christena H. Liechty, Fremont, CA (US); Stephen N. Webber, Cedar Hills, UT (US); Lanny E. Walker, Cedar Hills, UT (US)

Correspondence Address: KIRTON & McCONKIE, 1800 Eagle Gate Tower, 60 East South Temple, Salt Lake City, UT, 84111, US

(21) Appl. No.: 10/651,148

(22) Filed: Aug. 28, 2003

Related U.S. Application Data
(60) Provisional application No. 60/406,498, filed on Aug. 28, 2002.

(51) Int. Cl. G09F 3/18

(52) U.S. Cl. 40/661.04; 40/586

(57) ABSTRACT

A method for utilizing a tie protector in promoting a business. The tie protector box may be embellished to resemble a greeting card and to have appropriate graphics for a particular occasion.

### RELATED APPLICATIONS

This application claims the benefit of Provisional Application No. 60/406,498 entitled, “Necktie Protector Which Can Serve as Advertising or a Greeting Card,” filed on Aug. 28, 2002.

### BACKGROUND

1. Field of the Invention

This invention relates to necktie protectors, and more particularly, to a necktie protector that may be used as a greeting card, or to facilitate advertising or marketing.

2. Background Art

A variety of necktie storage and protective cases are known. Indeed, it is not unusual for necktie manufacturers to provide a cardboard necktie protector insert as part of standard necktie packaging. In addition, some dry cleaning establishments return a cleaned necktie to a patron within a cardboard necktie protector.

Although such necktie protectors serve their purpose in facilitating a necktie's pressed appearance until the customer arrives at his destination, such necktie protectors are typically fairly flimsy and thus tend to be promptly discarded. Such necktie protectors are also typically devoid of any print or graphic design, and thus fail to promote or enhance sales or future business.

Accordingly, what is needed is a necktie protector that may be used to advertise, educate and promote future business. What is further needed is a fairly sturdy necktie protector that may be used and re-used such that the advertising or message contained thereon may be regularly observed. Finally what is needed is a necktie protector that may be easily adapted to display advertising particular to a specific individual or company.

Such necktie protectors and methods for using the same are disclosed and claimed herein.

### SUMMARY AND OBJECTS OF THE INVENTION

This invention comprises a reusable tie protector for keeping ties substantially wrinkle-free, and method of messaging, advertising and/or marketing using the same.

Specifically, a necktie protector may implement print and/or graphic design to display a message, advertising or the like. A necktie protector according to one embodiment of the present invention, for example, may be used as a greeting card or gift card wherein the outer and/or inner surface of the tie protector may be printed to convey thoughts of a specific holiday or other occasion, such as messages of endearment, humor, greetings, wishes, or congratulations for a special occasion.

According to another embodiment of the present invention, a necktie protector may be used to convey advertising. Specifically, the necktie protector may convey information about a particular company, and may include marketing material to incentivize the recipient to purchase products or participate in promotional schemes.

In another embodiment, the necktie protector may be decorated with seasonal or colorful patterns designed to imitate wrapping paper. According to this embodiment of the present invention, the necktie protector may also incorporate text on the inner and/or outer surfaces of the tie protector to convey a greeting, advertisement or the like.

In another embodiment, the necktie protector may be used in connection with raising funds for various organizations. For example, schools, scouts, sports teams, fraternities, and/or other profit-based or nonprofit organizations may offer to sell ties to raise funds for their organization, and may use the necktie protector to educate the purchaser about the organization and to promote the organization through advertising.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The foregoing and other objects and features of the present invention will become more fully apparent from the accompanying drawings when considered in conjunction with the following description and appended claims. Although the drawings depict only typical embodiments of the invention and are thus not to be deemed limiting of the invention's scope, the accompanying drawings help explain the invention in added detail.

FIGS. 1 through 7 depict certain embodiments of the present invention wherein a necktie protector is constructed as a folded sheet-like material.

### DETAILED DESCRIPTION OF THE INVENTION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

As used in this specification, the term “tie” or “necktie” refers to a band or scarf worn around the neck, as commonly sold by men's clothing shops or haberdashers.

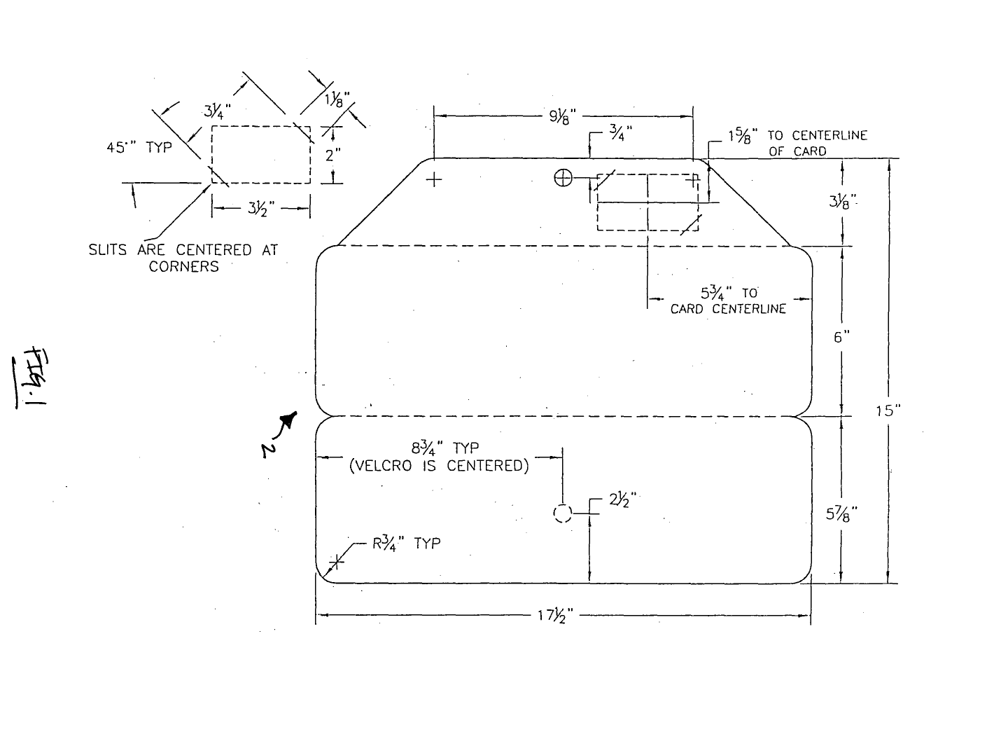

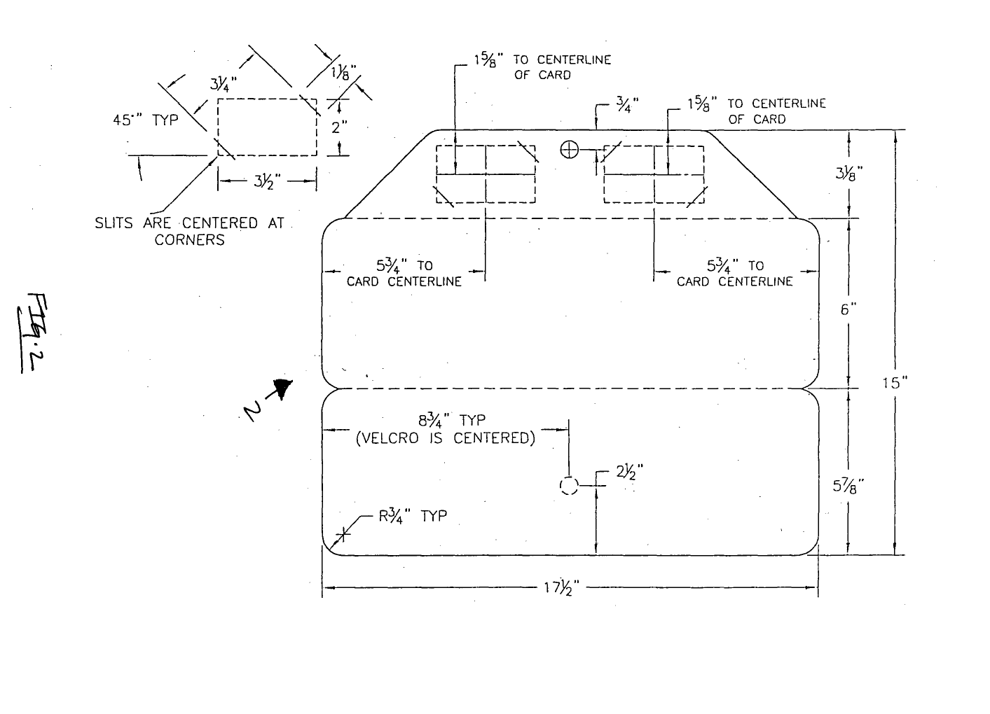

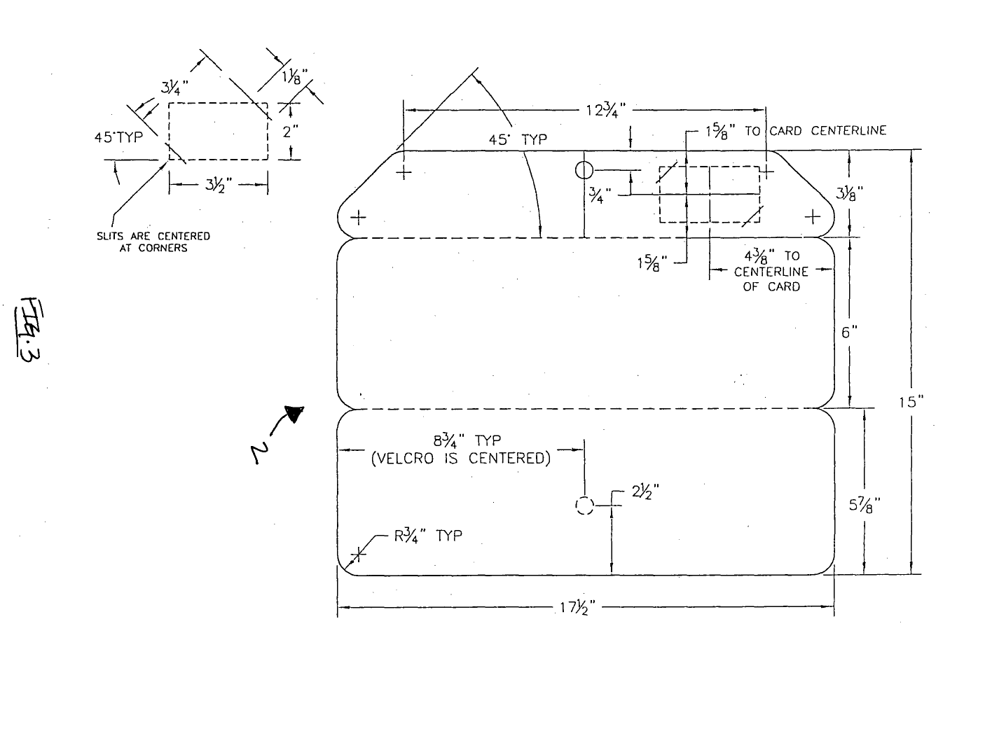

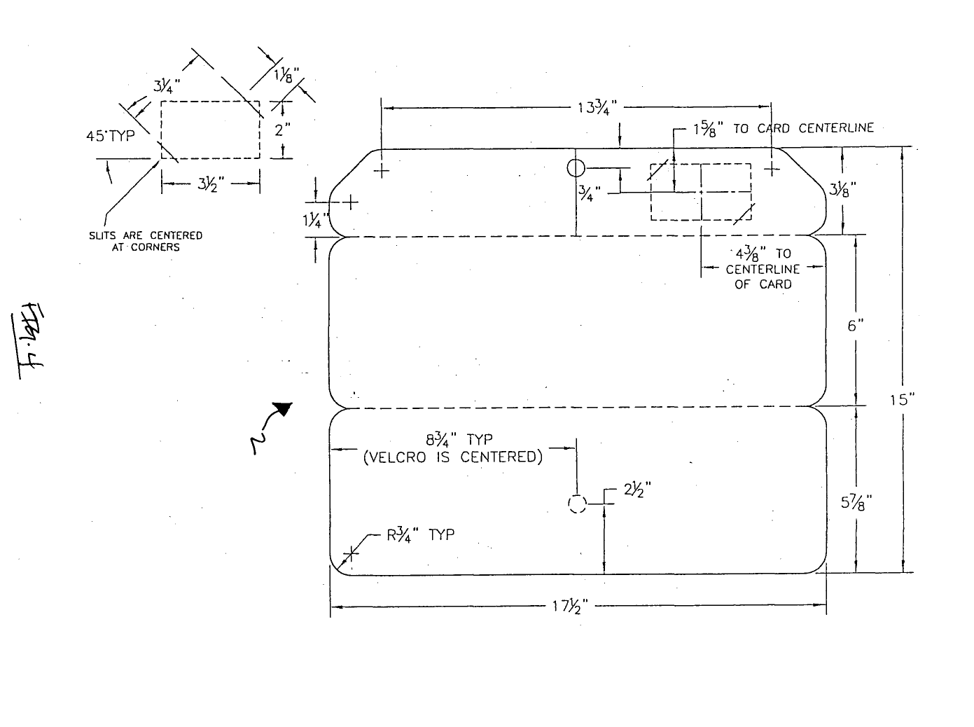

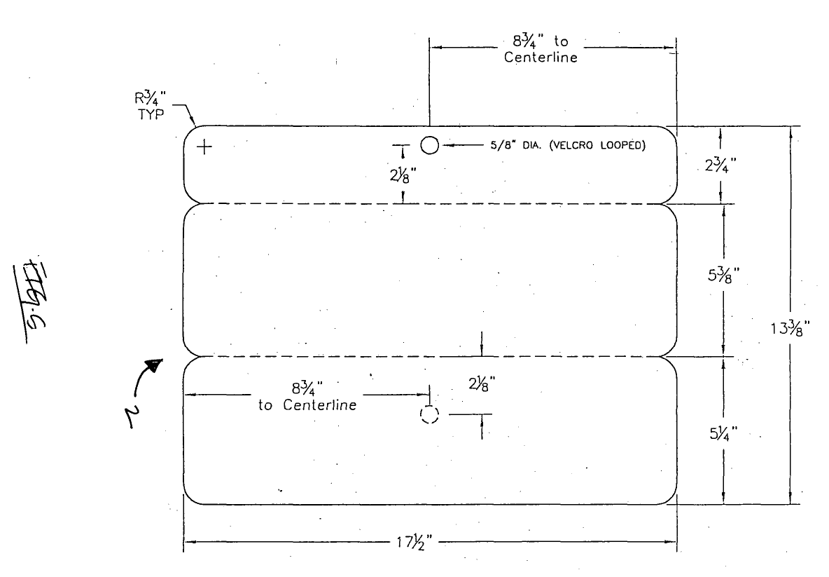

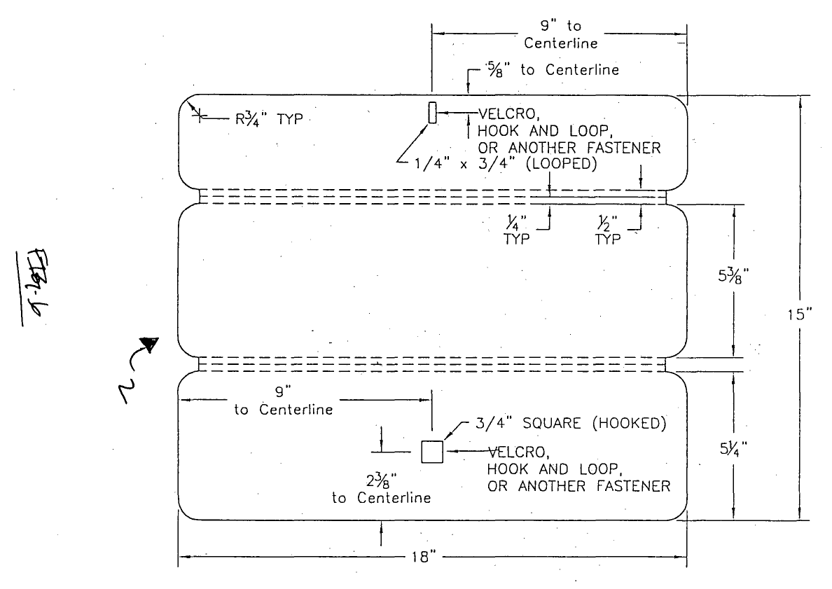

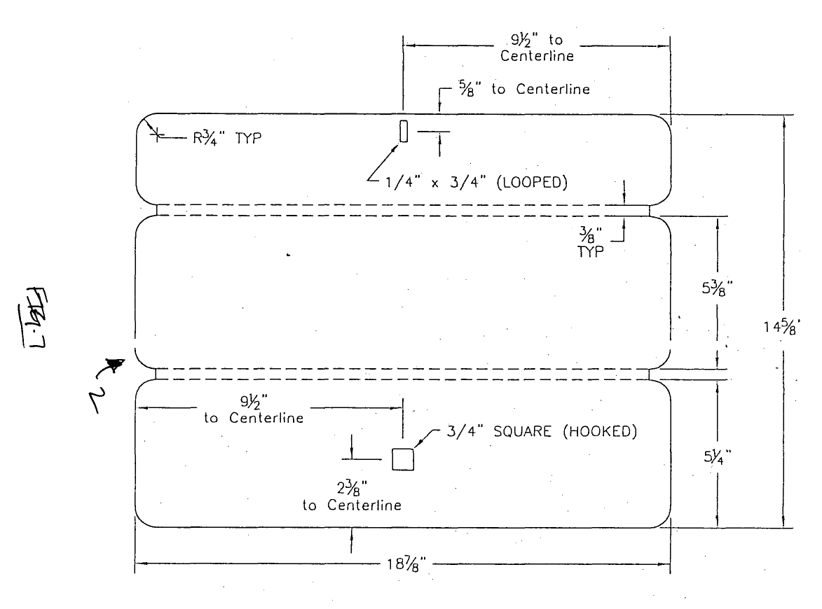

As can be seen in FIGS. 1 through 7, a necktie protector 2 in accordance with certain embodiments of the present invention may comprise any flexible, foldable material adapted to hold and/or protect one or more ties. A necktie protector 2 may comprise cardboard, plastic, treated cloth, metal, wood, or any other material known to those in the art that may be folded or adapted to hold and/or protect a tie, and which provides sufficient surface area on which to accommodate advertising or other printed material. Preferably, a necktie protector 2 comprises an inexpensive, yet sturdy material to facilitate its usefulness over time. Indeed, a quality tie protector is not likely to be discarded quickly, and may thus serve as a more effective advertising or marketing tool than a business card, gift bag, gift box, newspaper advertisement, radio advertisement or the like.

It will also be appreciated that the size and shape of the necktie protector 2 can vary depending on the needs of the manufacturer or organization, and according to the dimensions of the tie or ties for which it is intended. Preferably, however, a necktie protector 2 comprises a size and shape that may be easily accommodated by the top cover of a suitcase or the interior of a briefcase. The corners of a necktie protector 2 may be rounded to prevent fray or wear over time. Further, a necktie protector 2 may include expanding means such that the dimensions of the protector 2 may expand as necessary to accommodate an increased number of neckties 4.

Certain embodiments of a necktie protector 2 may implement a fastener 6 to ensure that an enclosed necktie 4 is adequately protected. By way of example and not limitation, a fastener 6 may comprise Velcro®, hook and loop, tab and slot, snaps, brads, a string tie fastened around at least two riveted or otherwise attached connecting points, adhesive, rubber band, acrylic glass, capillary action, or any other automatic or manually operated fastener device known to those in the art.

According to certain embodiments of the present invention, a necktie protector 2 may be used as a greeting card that also includes a gift. The outside of the tie protector 2 may be decorated with graphics for the occasion. The tie protector 2 may also provide a location for a personalized message or business card. Such a location for a personalized message or business card may comprise a slot for business or other informational cards, or pockets or other areas to accommodate brochures, instructional diagrams, logos, cooperative sponsor advertisements, reminders for upcoming promotions and sales, location addresses, maps, web sites, phone numbers, and the like.

Inside the tie protector 2 can be a necktie 4 or a gift certificate for an individual to purchase a necktie 4 or other products, or a coupon or other value-added promotional item or marketing tool. Alternatively, such coupons, gift certificates, or other value-added promotional or marketing tools may be printed on a surface of the necktie protector. In certain embodiments, the tie protector 2 may be reused and forwarded to a third party for the same or another purpose by simply replacing the business card or other advertising or organization promoting material originally enclosed.

In another embodiment of the present invention, a nonprofit organization could place their information on the tie protector 2 and sell the tie protector 2, including the necktie 4, to interested third parties willing to contribute to the organization. The tie protector 2 may incorporate information regarding the nonprofit organization with their thanks for purchasing the necktie 4.

It will be appreciated by those skilled in the business art that the marketing and advertising opportunities using this method are many and that only a few preferred embodiments have been set forth herein.

What is claimed is:

1. A method for doing business comprising:
providing a tie protector for accommodating a necktie;
printing on said tie protector information selected by an organization to promote the business of said organization;
providing the tie protector to an actual or potential customer.

2. The method of claim 1, wherein said information comprises a greeting card message.

3. The method of claim 1, wherein said information comprises advertising information.

4. A method for utilizing a tie protector in advertising comprising:
printing on the tie protector information regarding a business or a promotion sponsored by the business;
inserting into the tie protector at least one of the group consisting of coupons, gift certificates and other value-added promotional materials or marketing tools; and
providing the tie protector to customers.
